(19) United States
(12) Patent Application Publication
(10) Pub. No.: US 2018/0015375 A1
(43) Pub. Date: Jan. 18, 2018

(54) COMPUTER-IMPLEMENTED MULTIPLAYER COMBAT VIDEO GAME METHOD AND APPARATUS

(71) Applicant: Paul Marino, San Jose, CA (US)

(72) Inventor: Paul Marino, San Jose, CA (US)

(21) Appl. No.: 15/208,539

(22) Filed: Jul. 12, 2016

(51) Int. Cl. A63F 13/843; A63F 13/537; A63F 13/833; A63F 13/837

(52) U.S. Cl. CPC A63F 13/843; A63F 13/837; A63F 13/537; A63F 13/833

(57) ABSTRACT

Disclosed is a method for enabling a plurality of players to play a two-dimensional, multiplayer video game that involves a plurality of game characters, each of which represented by a player, the characters deployed for combat within, at one time, one of a plurality of virtual battlefields, each battlefield comprising a plurality of platforms disposed parallel to one another, the characters adapted to be controllably moved between the plurality of platforms and perform a plurality of actions, the game generated by a game processor by executing a game software residing within a game memory, selectively associating a character with a player, each character selectively associated with at least one firearm, each of which is adapted to be controlled by the player, enabling the character to aim and fire a firearm at any angle with respect to the horizontal resulting in the targets being hit through the platforms.

### BACKGROUND

### FIELD OF THE INVENTION

The present invention relates to computer video games and more particularly a two-dimensional, multiplayer combat video game.

The arrival of high-speed Internet access brought with it a surge in the Internet-based multiplayer video games that allow gamers from all over the world to join in and compete with one another. These multiplayer games come in all genres including first-person shooters, third-person shooters, light gun shooters, two dimensional shoot 'em ups, etc. As the gaming industry is cut-throat competitive, the game-makers constantly need to come up with new tricks and ideas to stay afloat, let alone be successful, in the market. Aside from the very game itself, one of the aspects of a game that keeps a gamer interested is offering products that are configured to be highly customized and personalized. The incentive system is another key aspect of gaming that helps to create and sustain gamer base for a game. These incentives are offered by way of trophies achieved, scores achieved, levels surpassed, ratings, etc. But the most important element of gaming that keeps gamers coming back for more is the unpredictability factor of the game. In today's gamers' minds, the more the game is unpredictable, the more fun it is. As mentioned earlier, as the gaming market is highly competitive, a game that endeavors to be as unpredictable as possible is a welcome product in the market.

### SUMMARY

An embodiment of the present invention comprises a game apparatus for enabling a plurality of players to play a computer-implemented two-dimensional multiplayer combat video game. The game apparatus comprises a game console (or a computer), wherein a game console comprises a game memory and a game processor. The game is rendered upon the game processor executing game software disposed within the game memory. The visual output of the game is rendered upon a display device disposed in operative communication with the game console, while sound thereof emanates from the one or more speakers disposed in operative communication with the game console as well. The game console is connected with a plurality of handheld game controllers about which, players interact with the game. Alternatively, the game can be executed in an arcade type mode for single players or for cooperative play.

The game involves a plurality of video game characters wherein, each player within a game is represented by a character that is chosen by the player himself/herself. Each character comes with its unique set of character traits such as, physical dimensions, agility, the amount (quantifiable) of damage per hit he/she inflicts on a fellow character (i.e., an opponent), walk speed, height of the jump, etc. Additionally, each character comes equipped with one (i.e., primary) or two (i.e., primary and secondary) weapons that are used to inflict damage on the fellow opponent characters. Examples of the weapons includes a variety of firearms including a mini-gun, rocket launcher, dual pistols, flame thrower, shot gun, grenade launcher, etc.

The game further involves a plurality of virtual battlefields within which, the competing players (and thereby the characters thereof) battle one another. In one embodiment, the battlefield is associated with a stage wherein, upon the completion of a stage, the winning character or characters are introduced into the next battlefield representative of the next stage, where the winner(s) are pitted against a new opponent(s). In a playlist embodiment of the present invention, the players are enabled to create “Stage Playlists” where every player advances to the next stage or a random stage from the playlist as per his/her selection regardless of the outcome. Notably, the view of the game is from profile of the battlefield.

The characters are capable of performing multiple actions including, jumping, double-jumping, running, dashing, infinite dashing, attacking, shooting, grenade-throwing, etc., wherein, these actions serve as a part of offensive and defensive tactics that are instrumental in winning a game. With plurality of battlefields, characters and their traits, weapons, attacks and actions, the game offers virtually infinite game play possibilities making it unpredictable and thereby fun to play.

The game initiates with a player selecting a character from a home screen. The multiple characters selected by multiple players are displayed on the respective display screens of the players. Upon the selection of a character by a player, the player is further tasked with equipping his/her character with aforementioned weapons. In one embodiment, while there will be options for players to customize battle elements such as, changing the default secondary weapon from a Peashooter to something else, etc., the player will not necessarily be further tasked with selecting a weapon because, as mentioned later in the document, specific characters start with specific guns. Further, the players are enabled to change different things at the character select screen such as changing the name, color, team, whether or not you can hurt your own teammate (friendly fire), etc. In one embodiment, fun things will be available for players as well if they choose such as items like air strikes, shields, etc. Furthermore, in some embodiments, the players have the ability to alter controller vibration, handicap starting number of lives for certain players, violence in the game such as, a paintball mode, where there are different color bullets and blood, etc. In one embodiment, the player has the ability to change the gravity of the game. In one embodiment, the players are enabled to customize the button layout and can make any button on the gamepad or key on the keyboard do any of the eight actions. Upon the selection of the weapons for the character, the player, by pressing a designated START button on the game controller, initiates the game. In the playlist embodiment, after all players have selected their characters and equipping them with weapons, pressing the START button leads to a stage select screen. At this point the players can either add to a Stage Playlist or simply go to a stage depending on the buttons they press. Similarly, At this point, the character is introduced into a battlefield to be fought against one or more opponents representative of the fellow players. Within a battlefield, each character is associated with a health indicator, which is a container of health. Upon the commencement of the game, a player attacks and shoots an opponent resulting in the opponent incurring damages. As a player (or character) incurs damages from the battle, the health within the health indicator gets drained until there's none of it left resulting in the character being dead. Upon the death of a character, the ghost of the characters rises up from the character's body. The game is configured such that, the player controls the ghost to move it to a desired location on the battlefield. Upon doing so, the player activates a spawning feature on the game controller resulting in the character being resurrected or spawned. The criteria for a player to win over his/her opponent is the opponent being dead a predetermined number of times or the opponent being dead most number of times within a predetermined combat time window.

The game is configured such that, the player performs the following actions:
Movement: The player can move left or right by pressing LEFT or RIGHT on the game controller. There will be a few frames where the player accelerates into their character's unique walk speed.
Dash: If the player quickly inputs LEFT immediately after inputting LEFT (on the game controller) or similarly RIGHT after RIGHT immediately (on the game controller) then the character will perform a dash.
Infinite dashing: There is a window of about 10 frames or so where they player can input LEFT or RIGHT during the dash to dash again, which is called “Infinite Dashing”. While a dash can only be initiated from the ground, the infinite dashing can be activated when the character is on the ground or in air. Notably, performing certain actions, such as shooting certain guns and executing attacks mid-dash will make the ability to execute infinite dashing impossible.
Evade Roll: Activated by the player by inputting DOWN after immediately inputting DOWN when on the ground and when not already dashing or acting. When used, the character performs an invincible roll followed by a brief recovery.
Aim: The player will be able to aim their firearm at any angle by operating UP, DOWN, LEFT, and RIGHT on the game controller. The player is enabled to aim his/her firearm when they are not performing an action already unless it is during the recovery frames of an attack. The rules for aiming are as follows: If the player's intention is to aim 180 degrees (horizontal), then the character will instantly begin aiming in that direction when shoot function is deployed using the game controller. In other words, 180 degrees is a default shoot setting. However, if the player intends to aim at an angle other than 180 degrees, the player by operating the UP, DOWN, LEFT and RIGHT keys on the game controller rotates the characters arm to a desired angle. Notably, the game is configured such that, the ammunition from the firearm is passes through the platforms in the event of the aiming angle being anything other than 180 degrees. In one alternative embodiment, the platforms are divided into thick and thin platforms wherein, the ammunition passes only through thin platforms. Further notably, the vaster the difference in the aim intention from the current aim, the faster the character's gun will rotate. So small adjustments will see the gun moving slower. With practice, the players can be very precise as aiming will be second nature.
Aim lock: Actuating the game controller key or keys assigned to aim lock (hereafter AIM LOCK) on the game controller results in the aiming angle of the character's firearm-holding arm being locked. The aim lock key is a hold type key wherein, if it is pressed and held, then it is activated, and if it is released, then it is deactivated. This will cause the character to move slower if they are walking/dashing in the opposite direction they are facing. There is an exception, however. If AIM LOCK is double tapped and then held after the second press then the character will be put into a Walk state where they move slower and aim slower for more precise aiming. Probably will be a very esoteric tactic that most people will ignore. The main AIM LOCK function is very important however because it enables you to aim one way while moving another or to keep your gun at the perfect angle.
Jump: JUMP (on the game controller) can be pressed and released quickly to perform a short hop and held for four frames or more to perform a jump. Additionally, if in the air and it has not been executed yet in that trip to the air, then the player can press JUMP to perform a double jump, or an in-air jump. A player can cancel the animations of certain attacks by pressing JUMP during them, including the ability to cancel most every aerial attack upon hitting an opponent. Further, JUMP and DOWN (buttons on the game controller) simultaneously while standing on a thin platform will allow the player to flip down through the platform. Further, JUMP is also used for the aforementioned spawning such that, a player, whose character is a ghost, upon actuating JUMP on the game controller results in the character being spawned.
Shoot: Actuating the game controller key or keys assigned for shooting will result in a firearm held by the player firing. Some firearms, such as the Minigun and the Flamethrower, will not affect a character's state. Others, such as the Shotgun and Rocket Launcher, will put the character in a state where they cannot perform any actions for a certain amount of time upon shooting. In last 25% or so of this state, they will, however, be freely able to perform certain actions such as dash, attack, and throw grenades. Additionally there is a window of a few frames upon firing that will enable you to dash at the cost of one or more portions of health. This is a dash cancel and will enable you to perform any action including firing your gun again instantly.
Attack: Actuating the game controller key or keys assigned for attacking is used to perform attacks. Every character has eight of their own unique attacks. The player can choose which attack to use by holding a directional keys (UP, DOWN, LEFT or RIGHT) or not while they actuate the keys assigned to perform attack. The character will perform a different attack depending on where the character is (i.e., whether on ground or in air). Most aerial moves will enable the player to press DOWN during them to start falling to the ground quickly. If a character is in the middle of an aerial attack, when they touch the ground they will cancel the animation of the attack and be in a free state to do whatever they want. Much like the dash-cancellable window during the firing of certain guns, you can dash cancel attacks.
Switch gun: Actuating the game controller keys assigned to switch gun will put the character in an animation that will end with the character holding their gun which they have in reserve while putting their last gun in reserve. Each character starts with a different gun as their primary weapon and a peashooter as their first reserve gun. A player can press game controller keys assigned to switch gun simultaneously with DOWN, while standing over a gun that is on a platform or a floor of the battlefield to pick it up. Upon picking a gun up which is not currently possessed, the reserve gun will be dropped to the floor. If it is possessed, then the player will be rewarded with ammo but will not switch guns. In one embodiment, the SWITCH GUN button is replaced with a RELOAD button. If a player taps the RELOAD button, the character will reload whereas, holding the RELOAD button will result in the aforementioned switch gun. However, if the player would want to instantly switch gun, he/she can still do so by pressing RELOAD and ATTACK buttons simultaneously (within two frame grace period). Further, a player is enabled to perform “Perfect Reload” and “Perfect Switch Gun” wherein, if the RELOAD button is pressed within a small specific window of the respective actions, then the animations are cut massively short and the character can freely act sooner.
Grenade: Actuating game controller keys assigned to grenade (hereinafter “GRENADE”) will result in throwing a grenade after being held for a certain amount of time or when GRENADE is released. As GRENADE is actuated, the speed in which the grenade comes out is alterable. As they actuate GRENADE, the player will be able to see a dynamically curved line emanating from their character to better understand where the grenade will go. “Grenade Cancelling” is a technique where the player throws a grenade in the middle of an otherwise not-free state. This will cancel their animation and will start the grenade-throwing process at the cost of two bars of health. There are different types of grenades that characters will start with and obtain from the battle by pressing DOWN when walking over them. The player can toggle between which grenade they will throw by pressing GRENADE SWITCH. GRENADE SWITCH will also work to bring down the power of the grenade throw simultaneously being attempted with GRENADE (if the power goes down to zero then the grenade will stop being attempted (free state) and the GRENADE button will have to be released and pressed again to initiate another grenade toss).

The game further comprises a power gauge that consists of six partitions. A player will be able to spend one bar for various techniques, grenade cancelling is now two bars as just mentioned four bars to go into a Super State, and all six bars to break out of an opponent's combo and go right into a Super state. To go into a Super State, press either JUMP, SHOOT, ATTACK, and SWITCH GUN simultaneously (there is a three-frame grace period between presses) or regardless of how you configure your buttons on a controller or fight stick you can press the two shoulder triggers. Alternatively, activating GRENADE and SHOOT2 buttons will initiate the super state .SHOOT will often be the primary offensive tool in a Super State, however some characters will have the ability to use ATTACK or GRENADE (unique from a normal state) during this time.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is a schematic block diagram depicting the components required for the deployment of the game.

FIG. 2, according to an embodiment of the present invention, depicts various exemplary video game characters.

FIG. 3, according to an embodiment of the present invention, depicts various exemplary weapons used by the game characters.

FIGS. 4 through 6, according to an embodiment of the present invention, are screenshots of various exemplary battlefields.

FIG. 7, according to an embodiment of the present invention, is a screenshot of an exemplary home screen.

FIG. 8, according to an embodiment of the present invention, is a screenshot of an exemplary battlefield selection page.

FIG. 9, according to an embodiment of the present invention, is a screenshot of an exemplary countdown page.

FIGS. 10 and 11, according to an embodiment of the present invention, are screenshots of the exemplary results pages.

FIG. 12, according to an embodiment of the present invention, is a screenshot of an exemplary macho ball battlefield, where a hit spark is being portrayed unique to counter hits.

### FIGURES—REFERENCE NUMERALS

10—Game Console
12—Game Memory
14—Game Processor
16—Display Device
18—Speaker
20—Game Server
22—Radio Communications Network
23—Game Controller
24—Macho
26—Duck Man
28—Glen McKay
30—Jackson Hatchet
32—Alexander Tyson
34—DP Girl
35—Video Game Character
36—Battlefield
38—Platform
40—Macho Ball
42—Home Screen
44—Results Page
46—Statistics Section
48—Settings Section
50—Health Indicator

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

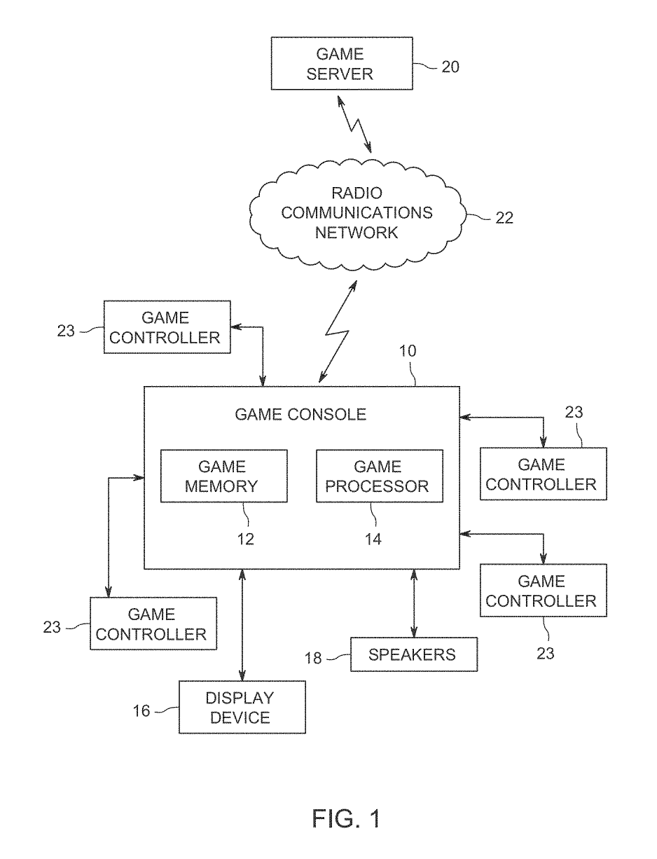

Referring to FIG. 1, the present invention comprises a method for enabling a plurality of players to play a computer-implemented two-dimensional multiplayer combat video game. The game is downloadable onto a game console 10 (or a computer), wherein a game console 10 comprises a game memory 12 and a game processor 14. The game is rendered upon the game processor 14 executing game software disposed within the game memory 12. The visual output of the game is rendered upon a display device 16 disposed in operative communication with the game console 10, while sound thereof emanates from the one or more speakers 18 disposed in operative communication with the game console 12 as well. The game software may be downloaded (onto the game console 10) from a remote game server 20 that is disposed in wireless communication with the game console via a radio communications network 22, such as the Internet. Alternatively, the game software may be downloaded (onto the game console 10) from a game disc (or another similar memory device) procured from the marketplace. The game console 12 is connected with a plurality of handheld game controllers 23 about which, players interact with the game.

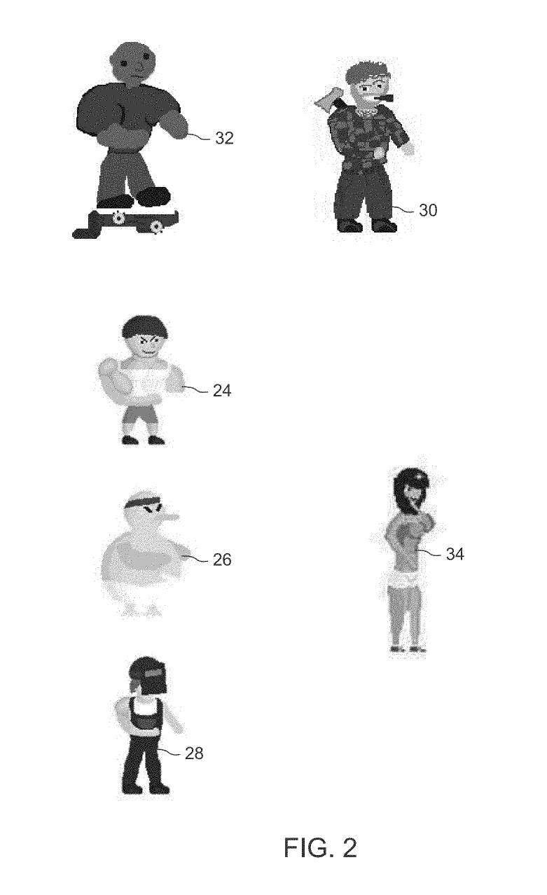

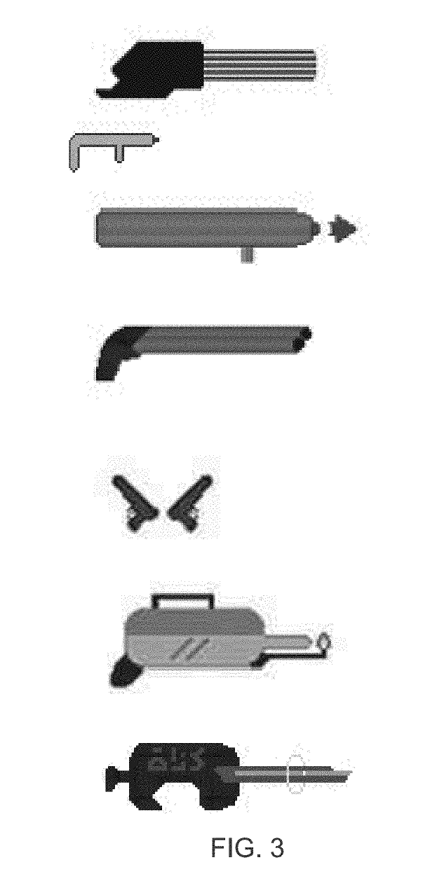

The game involves a plurality of video game characters 35 wherein, each player within a game is represented by a character 35 that is chosen by the player himself/herself out of a plurality of video game characters 35 as shown in FIGS. 2 and 7. Each character 35 comes with its unique character traits such as, physical dimensions, agility, the amount (quantifiable) of damage per hit he/she inflicts on a fellow character (i.e., an opponent), walk speed, height of the jump, etc. Additionally, each character 35 comes equipped with one (i.e., primary) or two (i.e., primary and secondary) weapons that are used to inflict damage on the fellow opponent characters that represent fellow opponent players. Notably, of the weapons carried by the players (i.e., the characters 35), the primary weapon is bound to be carried and can never be replaced or dropped. As can be appreciated from FIG. 3, examples of the weapons are projectile weapons including mini-gun, rocket launcher, dual pistols, flame thrower, shot gun, grenade launcher, etc. Other types of projectile weapons include grenade, Molotov cocktail (petrol bomb), etc. Alternatively, the weapons may include non-projectile weapons that may include a baseball bat, knuckle duster, dagger, sword, whip, etc. Notably, the game is configured such that, the players (represented by the characters thereof) may battle the fellow players individually or may form into groups that are pitted against one another in combat.

Referring to FIG. 2, the exemplary characters include:
Macho 24: He invented the sport of arena battling. Macho is the face of the game and is an international celebrity. He has a jack-of-all-trades fighting style and his primary weapon is the Minigun.
Duck Man 26: He comes from another dimension and is friends with everyone. He lives in Canada for large parts of the year. He is a very rush-down oriented character with fast and expansive movement options. His primary weapon is the Minigun.
Glen McKay 28: He is mysterious. He uses a flamethrower and wears a mask. He is a bit slower but his primary gun is the Flamethrower and jumps pretty high.
Jackson Hatchet 30: He moved to the forest when he realized that he frequently turned into a bear. He has a rush-down style and his primary gun is the Shotgun.
Alexander Tyson 32: He was a top prospect for playing professional basketball but when a meteor was coming to earth he risked his career to jump up and punch it into pieces and thereby save the world!! He is a hero and while he can never play basketball at a high level again, he does play in the Macho tournament and is also a bouncer at a night club. His primary gun is the Rocket Launcher
DP Girl 34: She is actually Macho's girlfriend and is very into acrobatics and aerobics. She is rush-down oriented (her speed is only second to Duck Man) and is very agile. She can run on ceilings and walls. Her primary gun is the dual pistols.

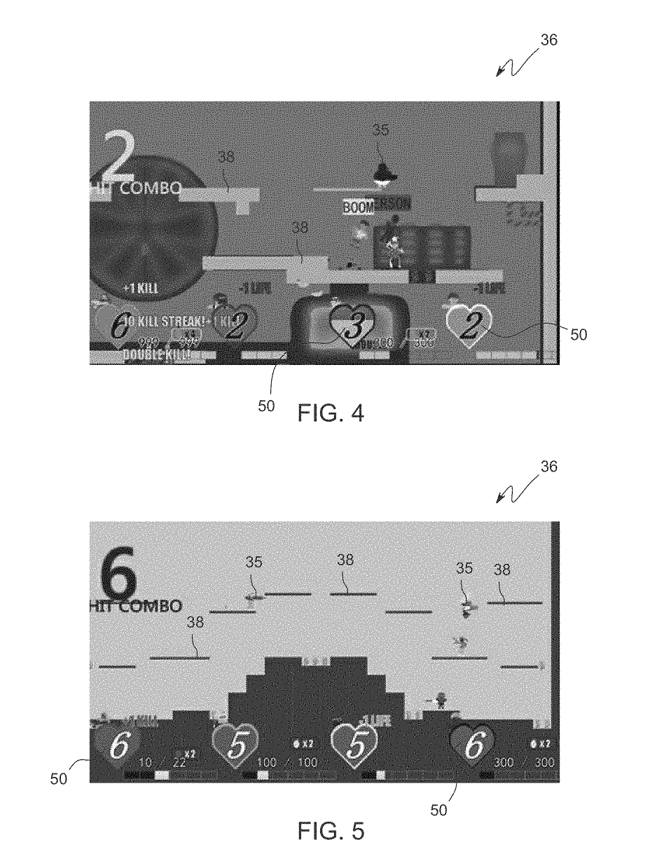

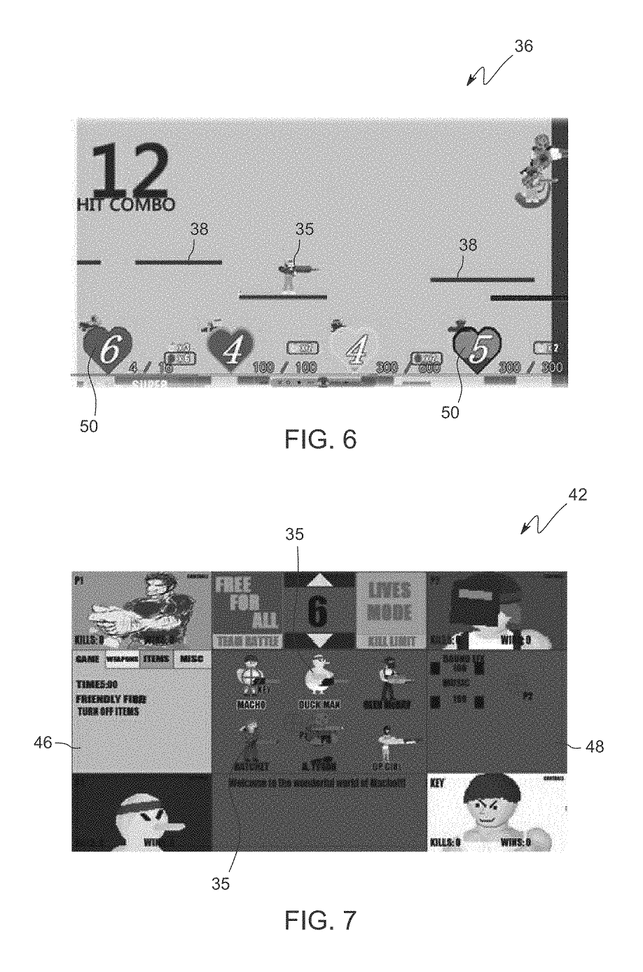

The game further involves a plurality of virtual battlefields within which, the competing players (and thereby the characters thereof) battle one another. In one embodiment, a battlefield is treated as a stage wherein, upon the completion of a stage, the winning character or characters are introduced into the next battlefield representative of the next stage, where the winner(s) are pitted against a new opponent(s). In a playlist embodiment of the present invention, the players are enabled to create “Stage Playlists” where every player advances to the next stage or a random stage from the playlist as per his/her selection regardless of the outcome. As can be appreciated from FIGS. 4 through 6, the view of the game is from profile of the battlefield 36. Each battlefield 36 comprises a plurality of platforms 38 wherein, during the course of the battle (or the game), the players (as represented by the respective characters thereof) move between the platforms by operating directional buttons (UP, DOWN, LEFT and RIGHT) on the respective controllers 23 thereof.

The characters 35 are capable of performing multiple actions including, jumping, double-jumping, running, dashing, infinite dashing, attacking, shooting, grenade-throwing, etc., wherein, these actions serve as a part of offensive and defensive tactics that are instrumental in winning a game. With plurality of battlefields, characters and their traits, weapons, attacks and actions, the game offers virtually infinite possibilities making it unpredictable and thereby fun to play.

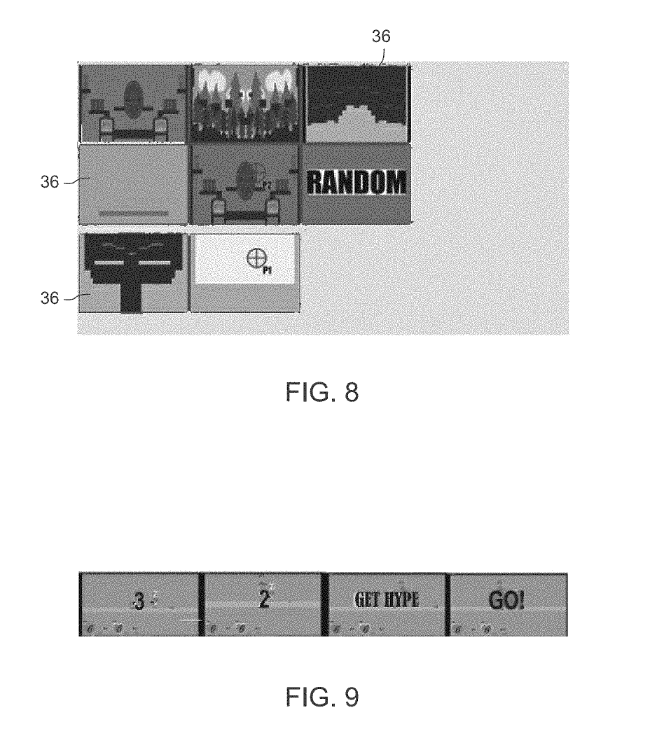

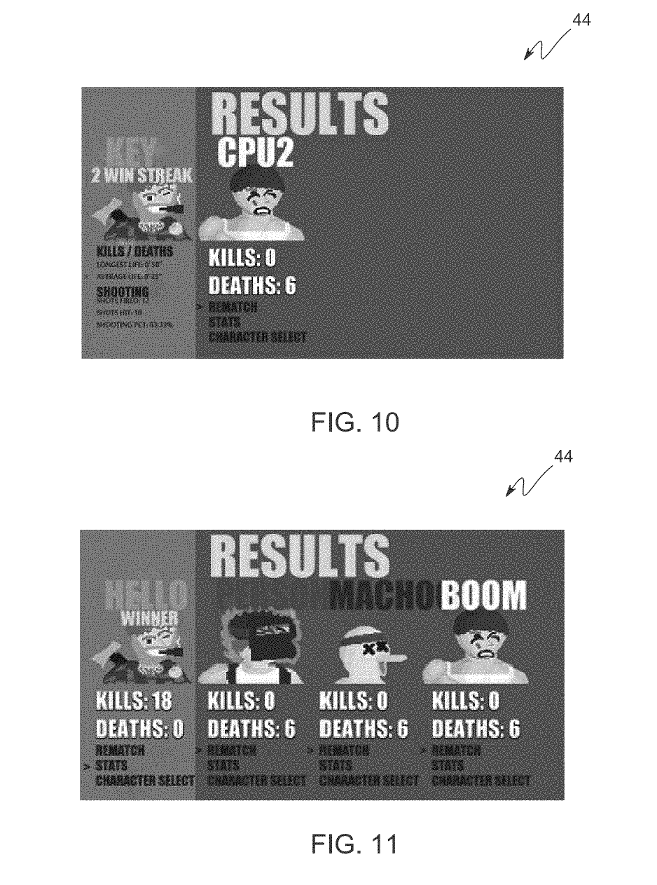

Referring to FIGS. 2, 3, 7 and 8, the method initiates with enabling a player to select, from a home screen 42, a character 35 from a plurality of characters 35. In one embodiment, the method involves enabling the player to name the selected character 35. The multiple characters selected by multiple players are displayed on the respective display screens of the players. In the event of game being played between groups, the method further comprises enabling players to form into groups. In one embodiment, the number of characters 35 that can be formed into a group is restricted to a predetermined number. In one embodiment, while there will be options for players to customize battle elements such as changing the default secondary weapon from a Peashooter to something else, etc., the player will not necessarily be further tasked with selecting a weapon because, specific characters 35 start with specific guns. Further, the players are enabled to change different things at the character select screen such as changing the name, color, team, whether or not you can hurt your own teammate (friendly fire), etc. In one embodiment, fun things will be available for players as well if they choose such as items like air strikes, shields, etc. Furthermore, in some embodiments, the players have the ability to alter controller vibration, handicap starting number of lives for certain players, violence in the game such as, a paintball mode, where there are different color bullets and blood, etc. In one embodiment, the player has the ability to change the gravity of the game. In one embodiment, the players are enabled to customize the button layout and can make any button on the gamepad or key on the keyboard do any of the eight actions. Upon the completion of the selection of the aforementioned game elements, the player is enabled to initiate the game by actuating a designated START button on his/her controller. In the playlist embodiment, after all players have selected their characters and equipping them with weapons, pressing the START button leads to a stage select screen. At this point the players can either add to a Stage Playlist or simply go to a stage depending on the buttons they press. Before the game begins, as can be appreciated in FIG. 9, a countdown screen is displayed to the player displaying the following countdown sequence: “3”, “2”, “GET HYPE” and finally “GO!” The game is configured such that, during the countdown steps “3” and “2”, players are only allowed to perform only slow walking, jumping and double jumping. During “GET HYPE” players can run and dash along with of course jumping still and then on “GO!” the match fully begins. At this point, the character is introduced into a battlefield to be fought against one or more opponents representative of the fellow players. In one embodiment, the method further comprises enabling a player to select the battlefield 36 from a plurality of battlefields 36 as seen in FIG. 8. As can be appreciated from FIGS. 4 through 6, within a battlefield, each character is associated with a heart-shaped health indicator 50, which is a container of health. The method further comprises enabling a player to attack and shoot an opponent resulting in the opponent incurring damages. As a player (or character) incurs damages from the battle, the heath within the health indicator 50 gets drained until there's none of it left resulting in the character being dead. The criteria for a player to win over his/her opponent is the opponent being dead, the opponent being dead a predetermined number of times, or the opponent being dead most number of times within a predetermined time frames. In the event of a tie, the method further comprises introducing a sudden death more where, the time is extended until there's a winner. Upon the death of a character, the ghost of the characters rises up from the character's body. The method further comprises enabling the player to control the ghost to move the same to a desired location on the battlefield. The method further comprises enabling the player to activate a spawning feature on the game controller resulting in the character being resurrected. Further, the game is adapted to be played in five modes. Of the five modes, Lives Mode is where the opponent being dead could still result in a victory and it would be so because the opponent died a predetermined number of times, which, in this case, would be one. Further, a Kill Limit mode is where it is the player who has actually killed opponent(s) a predetermined number of times. A King of Macho mode allows the players to choose three characters and when one of their characters dies, the ghost of their next character comes out. If all opponents' teams are wiped out then a player or team wins. A Time mode has a scoring system of +3 for a kill, +1 for an assist (unless assisting a teammate since that would be double scoring for one kill), and −1 for a death. The player or team with the most points at the end of the predetermined time limit wins. Finally, the Macho Ball, which will be discussed in detail in the following body of text. In the event of a tie, the game goes into a sudden death mode where, the time is extended until there's a winner.

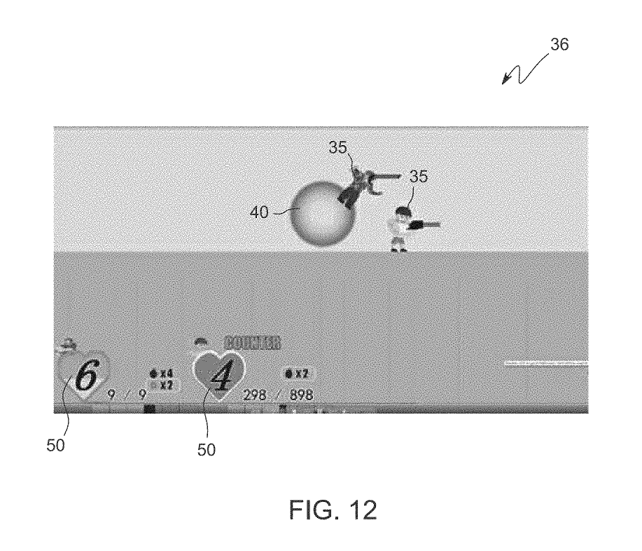

Referring to FIG. 12, in one embodiment, one of the battlefields comprises a macho ball battlefield. The macho ball battlefield 36 comprises a macho ball 40 wherein, criteria of the players playing the macho ball level is to move the macho ball 40 from a location within the macho ball battlefield to a target location. In this level, similar to the previous levels, the method further comprises enabling the players to attack the opponents by use of the weapons, etc., in order to achieve the goal of moving the macho ball 40 to the target location. In another embodiment, the criteria for winning the game comprises the player (i.e., the character) being at a target location for a predetermined amount of time.

The method further comprises enabling a player to perform the following actions:
Movement: The player can move left or right by pressing LEFT or RIGHT on the game controller. There will be a few frames where the player accelerates into their character's unique walk speed.
Dash: If the player quickly inputs LEFT immediately after inputting LEFT (on the game controller) or similarly RIGHT after RIGHT immediately (on the game controller) then the character will perform a dash.
Infinite dashing: There is a window of about 10 frames or so where they player can input LEFT or RIGHT during the dash to dash again, which is called “Infinite Dashing”. While a dash can only be initiated from the ground, the infinite dashing can be activated when the character is on the ground or in air. Notably, performing certain actions, such as shooting certain guns and executing attacks mid-dash will make the ability to execute infinite dashing impossible.
Evade Roll: Activated by the player by inputting DOWN after immediately inputting DOWN when on the ground and when not already dashing or acting. When used, the character performs an invincible roll followed by a brief recovery.
Aim: The player will be able to aim their firearm at any angle by operating UP, DOWN, LEFT, and RIGHT on the game controller. The player is enabled to aim his/her firearm when they are not performing an action already unless it is during the recovery frames of an attack. The rules for aiming are as follows: If the player's intention is to aim 180 degrees (horizontal), then the character will instantly begin aiming in that direction when shoot function is deployed using the game controller. In other words, 180 degrees is a default shoot setting. However, if the player intends to aim at an angle other than 180 degrees, the player by operating the UP, DOWN, LEFT and RIGHT keys on the game controller rotates the characters arm to a desired angle. Notably, the game is configured such that, the ammunition from the firearm is passes through the platforms in the event of the aiming angle being anything other than 180 degrees. Further notably, the vaster the difference in the aim intention from the current aim, the faster the character's gun will rotate. So small adjustments will see the gun moving slower. With practice, the players can be very precise as aiming will be second nature.
Aim lock: Actuating the game controller key or keys assigned to aim lock (hereafter AIM LOCK) on the game controller results in the aiming angle of the character's firearm-holding arm being locked. The aim lock key is a hold type key wherein, if it is pressed and held, then it is activated, and if it is released, then it is deactivated. This will cause the character to move slower if they are walking/dashing in the opposite direction they are facing. There is an exception, however. If AIM LOCK is double tapped and then held after the second press then the character will be put into a Walk state where they move slower and aim slower for more precise aiming. Probably will be a very esoteric tactic that most people will ignore. The main AIM LOCK function is very important however because it enables you to aim one way while moving another or to keep your gun at the perfect angle.
Jump: JUMP (on the game controller) can be pressed and released quickly to perform a short hop and held for four frames or more to perform a jump. Additionally, if in the air and it has not been executed yet in that trip to the air, then the player can press JUMP to perform a double jump, or an in-air jump. A player can cancel the animations of certain attacks by pressing JUMP during them, including the ability to cancel most every aerial attack upon hitting an opponent. Further, JUMP and DOWN (buttons on the game controller) simultaneously while standing on a thin platform will allow the player to flip down through the platform. Further, JUMP is also used for the aforementioned spawning such that, a player, whose character is a ghost, upon actuating JUMP on the game controller results in the character being spawned.
Shoot: Actuating the game controller key or keys assigned for shooting will result in a firearm held by the player firing. Some firearms, such as the Minigun and the Flamethrower, will not affect a character's state. Others, such as the Shotgun and Rocket Launcher, will put the character in a state where they cannot perform any actions for a certain amount of time upon shooting. In last 25% or so of this state, they will, however, be freely able to perform certain actions such as dash, attack, and throw grenades. Additionally there is a window of a few frames upon firing that will enable you to dash at the cost of one or more portions of health. This is a dash cancel and will enable you to perform any action including firing your gun again instantly.
Attack: Actuating the game controller key or keys assigned for attacking is used to perform attacks. Every character has eight of their own unique attacks. The player can choose which attack to use by holding a directional keys (UP, DOWN, LEFT or RIGHT) or not while they actuate the keys assigned to perform attack. The character will perform a different attack depending on where the character is (i.e., whether on ground or in air). Most aerial moves will enable the player to press DOWN during them to start falling to the ground quickly. If a character is in the middle of an aerial attack, when they touch the ground they will cancel the animation of the attack and be in a free state to do whatever they want. Much like the dash-cancellable window during the firing of certain guns, you can dash cancel attacks.
Switch gun: Actuating the game controller keys assigned to switch gun will put the character in an animation that will end with the character holding their gun which they have in reserve while putting their last gun in reserve. Each character starts with a different gun as their primary weapon and a peashooter as their first reserve gun. A player can press game controller keys assigned to switch gun simultaneously with DOWN, while standing over a gun that is on a platform or a floor of the battlefield to pick it up. Upon picking a gun up which is not currently possessed, the reserve gun will be dropped to the floor. If it is possessed, then the player will be rewarded with ammo but will not switch guns. In one embodiment, the SWITCH GUN button is replaced with a RELOAD button. If a player taps the RELOAD button, the character will reload whereas, holding the RELOAD button will result in the aforementioned switch gun. However, if the player would want to instantly switch gun, he/she can still do so by pressing RELOAD and ATTACK buttons simultaneously (within two frame grace period). Further, a player is enabled to perform “Perfect Reload” and “Perfect Switch Gun” wherein, if the RELOAD button is pressed within a small specific window of the respective actions, then the animations are cut massively short and the character can freely act sooner.
Grenade: Actuating game controller keys assigned to grenade (hereinafter “GRENADE”) will result in throwing a grenade after being held for a certain amount of time or when GRENADE is released. As GRENADE is actuated, the speed in which the grenade comes out is alterable. As they actuate GRENADE, the player will be able to see a dynamically curved line emanating from their character to better understand where the grenade will go. “Grenade Cancelling” is a technique where the player throws a grenade in the middle of an otherwise not-free state. This will cancel their animation and will start the grenade-throwing process at the cost of two bars of health. There are different types of grenades that characters will start with and obtain from the battle by pressing DOWN when walking over them. The player can toggle between which grenade they will throw by pressing GRENADE SWITCH. GRENADE SWITCH will also work to bring down the power of the grenade throw simultaneously being attempted with GRENADE (if the power goes down to zero then the grenade will stop being attempted (free state) and the GRENADE button will have to be released and pressed again to initiate another grenade toss).

The game further comprises a power gauge that consists of six partitions. A player will be able to spend one bar for various techniques, grenade cancelling is now two bars as just mentioned four bars to go into a Super State, and all six bars to break out of an opponent's combo and go right into a Super state. To go into a Super State, press either JUMP, SHOOT, ATTACK, and SWITCH GUN simultaneously (there is a three-frame grace period between presses) or regardless of how you configure your buttons on a controller or fight stick you can press the two shoulder triggers. Alternatively, activating GRENADE and SHOOT2 buttons will initiate the super state .SHOOT will often be the primary offensive tool in a Super State, however some characters will have the ability to use ATTACK or GRENADE (unique from a normal state) during this time.

When a character is hit by an attack, certain guns, grenades, etc., then they will be put into a juggle state. Depending on what they were hit by, they will have different hit reactions (Travel in different directions, travel at different speeds, have different hit stuns [be able to pop out sooner or later], etc.) If they are traveling fast enough then they will carom off of walls, ceilings, or the ground. If the player has been in a juggle state for longer than their hit stun, then they will be in an invincible tech state that can either be very brief with no direction pressed or can be extended shortly with aerial movement with any combination of UP, DOWN, LEFT, and RIGHT. If the player hits the ground without bouncing then they will have a four-frame opportunity while the character collapses on the ground to perform a tech with a button press. If during a successful tech, the player is not pressing LEFT or RIGHT then they will start getting up instantly. If they are pressing LEFT or RIGHT, then the character will perform a tech roll in the respective direction and then come out of it ready for action. If the player did not perform a tech during the window then they will be put into a state where they are knocked down. When this is over the player starts getting up. If a player is getting up, they cannot do many things, but they will be able to perform getup attacks. Depending on when the attack is executed, the amount of remaining invincible frames remaining for getting up are transferred to the beginning of the attack. After getting up or doing a getup attack, the player is free to act. Opponents will be able to perform combinations by keeping their opponents in a juggle state by making sure they do not exceed the hit stun time or hit the ground without bouncing. This will be made possible by doing anything the player can come up with based on the techniques at their disposal and the environment that is around them. The best combo masters will be those who utilize movement, shooting, attacking, and supers to their fullest.

When characters hit each other while both are attacking, then a counter-hit juggle state will be imposed on the character or characters who are cleanly hit. This can make the hit reaction vastly different. In addition, the gravity is less intense for a counter-hit juggled character. After a counter-hit juggle state character is hit four consecutive times without dropping out of the combo, then they will revert to a regular juggled state. In one embodiment, if the players hit each other not cleanly or rather hitbox to hitbox, there will be either a counter hit or a clash depending on each's moves' priority that is assigned to it. If the moves have differing priorities, then the one with more will have a clean-hit counter and if they are the same, then there will be a 16-frame window where the characters freeze in a dead lock before action is able to take place.

There is a combo system in place so that, as a character is hit multiple times with a same move then the hit reaction will change by either popping the other character up less or if an attack bounces the character against the ground then it will cause the character to just start being in a tech-able falling down state. Also each subsequent hit in a combo will do a less-and-less percentage of the base damage their hit does until 10 hits when a minimum damage percentage is multiplied. Additionally, there is a system in place to determine the height of the hit reaction for each hit. Each move adds to a variable called “Juggle” that lessens the height of hits more the higher the number it is. If a move is very easy to land and opens up big opportunities, it will often add more to the Juggle like 1 or 1.25. If it is a move that could not be followed up upon without rare circumstance or great skill, then it will add a low number to it such as 0.5 to as low as 0.1. To elaborate on the point earlier in the aforementioned combo syste, if a player uses the same move three times in a row, then the points added to Juggle will be doubled (eg. a 1.25 move is adding 2.5 to Juggle), as well as certain actions that will start doubling if only two are landed in a row, such as shotgun blasts. The initial hit in a counter counts for nothing towards the Juggle. Further, the Juggle has many nuances but it feels intuitive and keeps the combos very fresh and rewarding. Further, the damage scaling goes by not just hits in general but substantial hits. Notably, minigun bullets will not add to the damage scaling.

If a character is comboing one or more characters, there will be a number up at the top portion of the screen that displays how many consecutive hits a player has hit. Character portrait, health points, amount of lives, super meter, ammo, and grenade count are at the bottom of the screen.

Referring to FIG. 1, the present invention comprises a game apparatus for enabling a plurality of players to play a computer-implemented two-dimensional multiplayer combat video game. The game apparatus comprises a game console 10 (or a computer), wherein a game console 10 comprises a game memory 12 and a game processor 14. The game is rendered upon the game processor 14 executing game software disposed within the game memory 12. The visual output of the game is rendered upon a display device 16 disposed in operative communication with the game console 10, while sound thereof emanates from the one or more speakers 18 disposed in operative communication with the game console 12 as well. The game software may be downloaded (onto the game console 10) from a remote game server 20 that is disposed in wireless communication with the game console via a radio communications network 22, such as the Internet. Alternatively, the game software may be downloaded (onto the game console 10) from a game disc (or another similar memory device) procured from the marketplace. The game console 12 is connected with a plurality of handheld game controllers 23 about which, players interact with the game.

The game involves a plurality of video game characters 35 wherein, each player within a game is represented by a character 35 that is chosen by the player himself/herself out of a plurality of video game characters 35 as shown in FIGS. 2 and 7. Each character 35 comes with its unique character traits such as, physical dimensions, agility, the amount (quantifiable) of damage per hit he/she inflicts on a fellow character (i.e., an opponent), walk speed, height of the jump, etc. Additionally, each character 35 comes equipped with one (i.e., primary) or two (i.e., primary and secondary) weapons that are used to inflict damage on the fellow opponent characters that represent fellow opponent players. Notably, of the weapons carried by the players (i.e., the characters 35), the primary weapon is bound to be carried and can never be replaced or dropped. As can be appreciated from FIG. 3, examples of the weapons are projectile weapons including mini-gun, rocket launcher, dual pistols, flame thrower, shot gun, grenade launcher, etc. Other types of projectile weapons include grenade, Molotov cocktail (petrol bomb), etc. Alternatively, the weapons may include non-projectile weapons that may include a baseball bat, knuckle duster, dagger, sword, whip, etc. Notably, the game is configured such that, the players (represented by the characters thereof) may battle the fellow players individually or may form into groups that are pitted against one another in combat.

Referring to FIG. 2, the exemplary characters include:
Macho 24: He invented the sport of arena battling. Macho is the face of the game and is an international celebrity. He has a jack-of-all-trades fighting style and his primary weapon is the Minigun.
Duck Man 26: He comes from another dimension and is friends with everyone. He lives in Canada for large parts of the year. He is a very rush-down oriented character with fast and expansive movement options. His primary weapon is the Minigun.
Glen McKay 28: He is mysterious. He uses a flamethrower and wears a mask. He is a bit slower but his primary gun is the Flamethrower and jumps pretty high.
Jackson Hatchet 30: He moved to the forest when he realized that he frequently turned into a bear. He has a rush-down style and his primary gun is the Shotgun.
Alexander Tyson 32: He was a top prospect for playing professional basketball but when a meteor was coming to earth he risked his career to jump up and punch it into pieces and thereby save the world!! He is a hero and while he can never play basketball at a high level again, he does play in the Macho tournament and is also a bouncer at a night club. His primary gun is the Rocket Launcher
DP Girl 34: She is actually Macho's girlfriend and is very into acrobatics and aerobics. She is rush-down oriented (her speed is only second to Duck Man) and is very agile. She can run on ceilings and walls. Her primary gun is the dual pistols.

The game further involves a plurality of virtual battlefields within which, the competing players (and thereby the characters thereof) battle one another. In one embodiment, the battlefield is associated with a stage wherein, upon the completion of a stage, the winning character or characters are introduced into the next battlefield representative of the next stage, where the winner(s) are pitted against a new opponent(s). In a playlist embodiment of the present invention, the players are enabled to create “Stage Playlists” where every player advances to the next stage or a random stage from the playlist as per his/her selection regardless of the outcome. As can be appreciated from FIGS. 4 through 6, the view of the game is from profile of the battlefield 36. Each battlefield 36 comprises a plurality of platforms 38 wherein, during the course of the battle (or the game), the players (as represented by the respective characters thereof) move between the platforms by operating directional buttons (UP, DOWN, LEFT and RIGHT) on the respective controllers 23 thereof.

The characters 35 are capable of performing multiple actions including, jumping, double-jumping, running, dashing, infinite dashing, attacking, shooting, grenade-throwing, etc., wherein, these actions serve as a part of offensive and defensive tactics that are instrumental in winning a game. With plurality of battlefields, characters and their traits, weapons, attacks and actions, the game offers virtually infinite possibilities making it unpredictable and thereby fun to play.

Referring to FIGS. 2, 3, 7 and 8, the game initiates with a player selecting a character 35 (out of a plurality of characters 35) from a home screen 42. In one embodiment, the player is allowed to select a name for the selected character 35. As multiple characters selected by multiple players are displayed on the respective display screens of the players. In the event of game being played between groups, the game further enables players to form into groups. In one embodiment, the number of characters that can be formed into a group is restricted to a predetermined number. In one embodiment, while there will be options for players to customize battle elements such as changing the default secondary weapon from a Peashooter to something else, etc., the player will not necessarily be further tasked with selecting a weapon because, specific characters 35 start with specific guns. Further, the players are enabled to change different things at the character select screen such as changing the name, color, team, whether or not you can hurt your own teammate (friendly fire), etc. In one embodiment, fun things will be available for players as well if they choose such as items like air strikes, shields, etc. Furthermore, in some embodiments, the players have the ability to alter controller vibration, handicap starting number of lives for certain players, violence in the game such as, a paintball mode, where there are different color bullets and blood, etc. In one embodiment, the player has the ability to change the gravity of the game. In one embodiment, the players are enabled to customize the button layout and can make any button on the gamepad or key on the keyboard do any of the eight actions. Upon the completion of the selection of the weapons for the character, the player, by pressing a designated START button on the game controller, starts the game. In the playlist embodiment, after all players have selected their characters and equipping them with weapons, pressing the START button leads to a stage select screen. At this point the players can either add to a Stage Playlist or simply go to a stage depending on the buttons they press. Before the game begins, as can be appreciated in FIG. 9, a countdown screen is displayed to the player displaying the following countdown sequence: “3”, “2”, “GET HYPE” and finally “GO!” The game is configured such that, during the countdown steps “3” and “2”, players are only allowed to perform only slow walking, jumping and double jumping. During “GET HYPE” players can run and dash along with of course jumping still and then on “GO!” the match fully begins. At this point, the character is introduced into a battlefield to be fought against one or more opponents representative of the fellow players. In one embodiment, the player is prompted to select battlefield 36 from a plurality of battlefields 36 as seen in FIG. 8. As can be appreciated from FIGS. 4 through 6, within a battlefield, each character is associated with a heart-shaped health indicator 50, which is a container of health. Upon the commencement of the game, a player attacks and shoots an opponent resulting in the opponent incurring damages. As a player (or character) incurs damages from the battle, the heath within the health indicator 50 gets drained until there's none of it left resulting in the character being dead. The criteria for a player to win over his/her opponent is the opponent being dead, the opponent being dead a predetermined number of times, or the opponent being dead most number of times within a predetermined time frames. In the event of a tie, the game goes into a sudden death mode where, the time is extended until there's a winner. Upon the death of a character, the ghost of the characters rises up from the character's body. The game is configured such that, the player controls the ghost to move the same to a desired location on the battlefield. Upon doing so, the player activates a spawning feature on the game controller resulting in the character being resurrected or spawned. Further, the game is adapted to be played in five modes. Of the five modes, Lives Mode is where the opponent being dead could still result in a victory and it would be so because the opponent died a predetermined number of times, which, in this case, would be one. Further, a Kill Limit mode is where it is the player who has actually killed opponent(s) a predetermined number of times. A King of Macho mode allows the players to choose three characters and when one of their characters dies, the ghost of their next character comes out. If all opponents' teams are wiped out then a player or team wins. A Time mode has a scoring system of +3 for a kill, +1 for an assist (unless assisting a teammate since that would be double scoring for one kill), and −1 for a death. The player or team with the most points at the end of the predetermined time limit wins. Finally, the Macho Ball, which will be discussed in detail in the following body of text.

Referring to FIG. 12, in one embodiment, one of the battlefields comprises a macho ball battlefield. The macho ball battlefield 36 comprises a macho ball 40 wherein, criteria of the players playing the macho ball level is to move the macho ball 40 from a location within the macho ball battlefield to a target location. In this level, similar to the previous levels, the game is configured such that, the players attack the opponents by use of the weapons, etc., in order to achieve the goal of moving the macho ball 40 to the target location. In another embodiment, the criteria for winning the game comprises the player (i.e., the character) being at a target location for a predetermined amount of time.

The game is configured such that, the player performs the following actions:
Movement: The player can move left or right by pressing LEFT or RIGHT on the game controller. There will be a few frames where the player accelerates into their character's unique walk speed.
Dash: If the player quickly inputs LEFT immediately after inputting LEFT (on the game controller) or similarly RIGHT after RIGHT immediately (on the game controller) then the character will perform a dash.
Infinite dashing: There is a window of about 10 frames or so where they player can input LEFT or RIGHT during the dash to dash again, which is called “Infinite Dashing”. While a dash can only be initiated from the ground, the infinite dashing can be activated when the character is on the ground or in air. Notably, performing certain actions, such as shooting certain guns and executing attacks mid-dash will make the ability to execute infinite dashing impossible.
Evade Roll: Activated by the player by inputting DOWN after immediately inputting DOWN when on the ground and when not already dashing or acting. When used, the character performs an invincible roll followed by a brief recovery.
Aim: The player will be able to aim their firearm at any angle by operating UP, DOWN, LEFT, and RIGHT on the game controller. The player is enabled to aim his/her firearm when they are not performing an action already unless it is during the recovery frames of an attack. The rules for aiming are as follows: If the player's intention is to aim 180 degrees (horizontal), then the character will instantly begin aiming in that direction when shoot function is deployed using the game controller. In other words, 180 degrees is a default shoot setting. However, if the player intends to aim at an angle other than 180 degrees, the player by operating the UP, DOWN, LEFT and RIGHT keys on the game controller rotates the characters arm to a desired angle. Notably, the game is configured such that, the ammunition from the firearm is passes through the platforms in the event of the aiming angle being anything other than 180 degrees. Further notably, the vaster the difference in the aim intention from the current aim, the faster the character's gun will rotate. So small adjustments will see the gun moving slower. With practice, the players can be very precise as aiming will be second nature.
Aim lock: Actuating the game controller key or keys assigned to aim lock (hereafter AIM LOCK) on the game controller results in the aiming angle of the character's firearm-holding arm being locked. The aim lock key is a hold type key wherein, if it is pressed and held, then it is activated, and if it is released, then it is deactivated. This will cause the character to move slower if they are walking/dashing in the opposite direction they are facing. There is an exception, however. If AIM LOCK is double tapped and then held after the second press then the character will be put into a Walk state where they move slower and aim slower for more precise aiming. Probably will be a very esoteric tactic that most people will ignore. The main AIM LOCK function is very important however because it enables you to aim one way while moving another or to keep your gun at the perfect angle.
Jump: JUMP (on the game controller) can be pressed and released quickly to perform a short hop and held for four frames or more to perform a jump. Additionally, if in the air and it has not been executed yet in that trip to the air, then the player can press JUMP to perform a double jump, or an in-air jump. A player can cancel the animations of certain attacks by pressing JUMP during them, including the ability to cancel most every aerial attack upon hitting an opponent. Further, JUMP and DOWN (buttons on the game controller) simultaneously while standing on a thin platform will allow the player to flip down through the platform. Further, JUMP is also used for the aforementioned spawning such that, a player, whose character is a ghost, upon actuating JUMP on the game controller results in the character being spawned.
Shoot: Actuating the game controller key or keys assigned for shooting will result in a firearm held by the player firing. Some firearms, such as the Minigun and the Flamethrower, will not affect a character's state. Others, such as the Shotgun and Rocket Launcher, will put the character in a state where they cannot perform any actions for a certain amount of time upon shooting. In last 25% or so of this state, they will, however, be freely able to perform certain actions such as dash, attack, and throw grenades. Additionally there is a window of a few frames upon firing that will enable you to dash at the cost of one or more portions of health. This is a dash cancel and will enable you to perform any action including firing your gun again instantly.
Attack: Actuating the game controller key or keys assigned for attacking is used to perform attacks. Every character has eight of their own unique attacks. The player can choose which attack to use by holding a directional keys (UP, DOWN, LEFT or RIGHT) or not while they actuate the keys assigned to perform attack. The character will perform a different attack depending on where the character is (i.e., whether on ground or in air). Most aerial moves will enable the player to press DOWN during them to start falling to the ground quickly. If a character is in the middle of an aerial attack, when they touch the ground they will cancel the animation of the attack and be in a free state to do whatever they want. Much like the dash-cancellable window during the firing of certain guns, you can dash cancel attacks.
Switch gun: Actuating the game controller keys assigned to switch gun will put the character in an animation that will end with the character holding their gun which they have in reserve while putting their last gun in reserve. Each character starts with a different gun as their primary weapon and a peashooter as their first reserve gun. A player can press game controller keys assigned to switch gun simultaneously with DOWN, while standing over a gun that is on a platform or a floor of the battlefield to pick it up. Upon picking a gun up which is not currently possessed, the reserve gun will be dropped to the floor. If it is possessed then the player will be rewarded with ammo but will not switch guns. In one embodiment, the SWITCH GUN button is replaced with a RELOAD button. If a player taps the RELOAD button, the character will reload whereas, holding the RELOAD button will result in the aforementioned switch gun. However, if the player would want to instantly switch gun, he/she can still do so by pressing RELOAD and ATTACK buttons simultaneously (within two frame grace period). Further, a player is enabled to perform “Perfect Reload” and “Perfect Switch Gun” wherein, if the RELOAD button is pressed within a small specific window of the respective actions, then the animations are cut massively short and the character can freely act sooner.
Grenade: Actuating game controller keys assigned to grenade (hereinafter “GRENADE”) will result in throwing a grenade after being held for a certain amount of time or when GRENADE is released. As GRENADE is actuated, the speed in which the grenade comes out is alterable. As they actuate GRENADE, the player will be able to see a dynamically curved line emanating from their character to better understand where the grenade will go. “Grenade Cancelling” is a technique where the player throws a grenade in the middle of an otherwise not-free state. This will cancel their animation and will start the grenade-throwing process at the cost of two bars of health. There are different types of grenades that characters will start with and obtain from the battle by pressing DOWN when walking over them. The player can toggle between which grenade they will throw by pressing GRENADE SWITCH. GRENADE SWITCH will also work to bring down the power of the grenade throw simultaneously being attempted with GRENADE (if the power goes down to zero then the grenade will stop being attempted (free state) and the GRENADE button will have to be released and pressed again to initiate another grenade toss).

The game further comprises a power gauge that consists of six partitions. A player will be able to spend one bar for various techniques, grenade cancelling is now two bars as just mentioned four bars to go into a Super State, and all six bars to break out of an opponent's combo and go right into a Super state. To go into a Super State, press either JUMP, SHOOT, ATTACK, and SWITCH GUN simultaneously (there is a three-frame grace period between presses) or regardless of how you configure your buttons on a controller or fight stick you can press the two shoulder triggers. Alternatively, activating GRENADE and SHOOT2 buttons will initiate the super state .SHOOT will often be the primary offensive tool in a Super State, however some characters will have the ability to use ATTACK or GRENADE (unique from a normal state) during this time.

When a character is hit by an attack, certain guns, grenades, etc., then they will be put into a juggle state. Depending on what they were hit by, they will have different hit reactions (Travel in different directions, travel at different speeds, have different hit stuns [be able to pop out sooner or later], etc.) If they are traveling fast enough then they will carom off of walls, ceilings, or the ground. If the player has been in a juggle state for longer than their hit stun, then they will be in an invincible tech state that can either be very brief with no direction pressed or can be extended shortly with aerial movement with any combination of UP, DOWN, LEFT, and RIGHT. If the player hits the ground without bouncing then they will have a four-frame opportunity while the character collapses on the ground to perform a tech with a button press. If during a successful tech, the player is not pressing LEFT or RIGHT then they will start getting up instantly. If they are pressing LEFT or RIGHT, then the character will perform a tech roll in the respective direction and then come out of it ready for action. If the player did not perform a tech during the window then they will be put into a state where they are knocked down. When this is over the player starts getting up. If a player is getting up, they cannot do many things, but they will be able to perform getup attacks. Depending on when the attack is executed, the amount of remaining invincible frames remaining for getting up are transferred to the beginning of the attack. After getting up or doing a getup attack, the player is free to act. Opponents will be able to perform combinations by keeping their opponents in a juggle state by making sure they do not exceed the hit stun time or hit the ground without bouncing. This will be made possible by doing anything the player can come up with based on the techniques at their disposal and the environment that is around them. The best combo masters will be those who utilize movement, shooting, attacking, and supers to their fullest.

When characters hit each other while both are attacking, then a counter-hit juggle state will be imposed on the character or characters who are cleanly hit. This can make the hit reaction vastly different. In addition, the gravity is less intense for a counter-hit juggled character. After a counter-hit juggle state character is hit four consecutive times without dropping out of the combo, then they will revert to a regular juggled state. In one embodiment, if the players hit each other not cleanly or rather hitbox to hitbox, there will be either a counter hit or a clash depending on each's moves' priority that is assigned to it. If the moves have differing priorities, then the one with more will have a clean-hit counter and if they are the same, then there will be a 16-frame window where the characters freeze in a dead lock before action is able to take place.

There is a combo system in place so that, as a character is hit multiple times with a same move then the hit reaction will change by either popping the other character up less or if an attack bounces the character against the ground then it will cause the character to just start being in a tech-able falling down state. Also each subsequent hit in a combo will do a less-and-less percentage of the base damage their hit does until 10 hits when a minimum damage percentage is multiplied. Additionally, there is a system in place to determine the height of the hit reaction for each hit. Each move adds to a variable called “Juggle” that lessens the height of hits more the higher the number it is. If a move is very easy to land and opens up big opportunities, it will often add more to the Juggle like 1 or 1.25. If it is a move that could not be followed up upon without rare circumstance or great skill, then it will add a low number to it such as 0.5 to as low as 0.1. To elaborate on the point earlier in the aforementioned combo syste, if a player uses the same move three times in a row, then the points added to Juggle will be doubled (eg. a 1.25 move is adding 2.5 to Juggle), as well as certain actions that will start doubling if only two are landed in a row, such as shotgun blasts. The initial hit in a counter counts for nothing towards the Juggle. Further, the Juggle has many nuances but it feels intuitive and keeps the combos very fresh and rewarding. Further, the damage scaling goes by not just hits in general but substantial hits. Notably, minigun bullets will not add to the damage scaling.

If a character is comboing one or more characters, there will be a number up at the top portion of the screen that displays the characters' character portrait, health points, amount of lives, super meter, ammo, and grenade count at the bottom of the screen. This number says how many consecutive hits a player has hit.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A method for enabling a plurality of players, via the respective game controllers thereof, to participate in a two-dimensional, multiplayer combat video game that involves a plurality of different video game characters, each of which represented by a player, the characters deployed for combat within, at one time, one of a plurality of virtual battlefields, each battlefield comprising a plurality of platforms disposed parallel to one another, each character associated with a health bar, which representative of the health thereof, the character being dead in the event of the complete depletion of the health bar, the characters, by virtue of being controlled by the respective players via the controllers thereof, adapted to be controllably moved between the plurality of platforms, the characters, by virtue of being controlled by the respective players via the controllers thereof, adapted to controllably perform a plurality of actions, the game generated by a game processor by executing a game software residing within a game memory, the game processor and the game memory being a part of a game console, the game console disposed in operative communication with one or more game controllers, the method includes:
(a) associating a character with a player upon the selection of the character by the player, each character associated with at least one firearm, each of which is adapted to be controlled by the player by controlling the game controller thereof;
(b) enabling the character to aim and fire a firearm at an opponent (or opponents) at any angle resulting in the opponent being hit, the opponent comprising a fellow character pitted against the character.; and
(c) enabling the character to participate in hand combat with the opponent (or opponents) ; wherein, a player wins over an opponent (or opponents) upon the opponent being dead a predetermined number of times as a result of the firing, hand combat, or a combination thereof

2. The method of claim 1 further comprising enabling players to form the corresponding characters thereof into different groups that are pitted against one another for combat.

3. The method of claim 1 wherein, the plurality of actions include jumping, running, ducking and rolling.

4. The method of claim 1 wherein, the plurality of actions includes dashing, which comprises faster running.

5. The method of claim 4 wherein, dashing cannot be activated when a character is in air.

6. The method of claim 4 wherein, the plurality of actions further includes infinite dashing, which is dashing for an extended period of time, the infinite dashing to be activated during the dashing.

7. The method of claim 6 wherein, infinite dashing can be activated when a character is in air.

8. The method of claim 6 wherein, infinite dashing cannot be activated when the character fires the firearm thereof during the dash.

9. The method of claim 1 further comprising enabling a character to aim-lock the firearm thereof, which results in the hand of the character holding the firearm being at a selected angle irrespective of the direction of the movement of the character.

10. The method of claim 1 wherein, as a character takes hits from an opponent, the character's health bar is gradually depleted.

11. The method of claim 10 further comprising enabling a dead character to spawn.

12. The method of claim 11 wherein, a ghost of the character is displayed to be emerging from the character upon the death thereof; the movement of the ghost controlled by the corresponding player.

13. The method of claim 12 wherein, the spawn location for the spawn of a character is selected by the corresponding player by moving the ghost to a desired location on the battlefield before being selected to spawn.

14. The method of claim 1 further comprising enabling a player to throw a grenade.

15. The method of claim 1 wherein, the plurality of battlefields includes a macho ball battlefield;
the objective of the characters playing in the macho ball battlefield is to bring a ball to a target location thereon.

16. The method of claim 1 wherein, the view of the game is from the profile of the battlefield.

17. The method of claim 1 wherein, a character wins over an opponent (or opponents) upon the opponent being dead a predetermined number of times within a predetermined time window.

18. The method of claim 18 wherein, the predetermined time frame is extended upon there being a draw between the character and the opponent.

19. The method of claim 1 wherein, alternatively, a player wins over a fellow player (or fellow players), upon the player's character standing upon a spot on the battlefield for a predetermined amount of time.

20. The method of claim 1 wherein, the opponent is adapted to be hit through the platforms as the player fires thereat and vice versa.

21. The method of claim 1 wherein, the plurality of platforms are divided into thick and thin platforms; the opponent is adapted to be hit through the thin platforms as the player fires thereat and vice versa.

22. A gaming apparatus comprising:
(a) one or more game controllers, each of which operated by a player; and
(b) a game console disposed in operative communication with the one or more game controllers, the game console comprising:
(i) a game memory comprising game software; and
(ii) a game processor for executing the game software resulting in generating a two-dimensional, multiplayer combat video game, the game involving a plurality of different video game characters, each of which represented by a player, the characters deployed for combat within, at one time, one of a plurality of virtual battlefields, the view of the game being from the profile of the battlefield, each battlefield comprising a plurality of platforms disposed parallel to one another, the characters, by virtue of being controlled by the respective players via the controllers thereof, adapted to be controllably moved between the plurality of platforms, the characters, by virtue of being controlled by the respective players via the controllers thereof, adapted to controllably perform a plurality of actions, each character associated with a health bar, which representative of the health thereof, the character being dead in the event of the complete depletion of the health bar,
wherein, the game enabling a player:
(a) to select a character, the character associated with at least one firearm, each of which is adapted to be controlled by the player by controlling the game controller thereof;
(b) via the character thereof, to aim and fire a firearm at an opponent (or opponents) at any angle resulting in the in the opponent being hit, the opponent comprising a fellow character pitted against the character; and
(c) via the character thereof, to participate in hand combat with an opponent (or opponents) wherein, a player wins over an opponent (or opponents) upon the opponent being dead a predetermined number of times as a result of the firing, hand combat, or a combination thereof.

23. The apparatus of claim 22 wherein, players are enabled to form the corresponding characters thereof into different groups that are pitted against one another in combat.

24. The apparatus of claim 22 wherein, the plurality of actions include jumping, running, ducking and rolling.

25. The apparatus of claim 22 wherein, the plurality of actions includes dashing, which comprises faster running.

26. The apparatus of claim 25 wherein, dashing cannot be activated when a character is in air.

27. The apparatus of claim 25 wherein, infinite dashing cannot be activated when the character fires the firearm thereof during the dash.

28. The apparatus of claim 25 wherein, the plurality of actions further includes infinite dashing, which is dashing for an extended period of time, the infinite dashing to be activated during the dashing.

29. The apparatus of claim 28 wherein, infinite dashing can be activated when a character is in air.

30. The apparatus of claim 22 wherein, a player is further enabled to aim-lock the firearm thereof, which results in the hand of the character holding the firearm being at a selected angle irrespective of the direction of the movement of the character.

31. The apparatus of claim 22 wherein, as a character takes hits from an opponent, the character's health bar is gradually depleted.

32. The apparatus of claim 31 wherein, a player is enabled to spawn a dead character.

33. The apparatus of claim 32 wherein, a ghost of the character is displayed to be emerging from the character upon the death thereof; the movement of the ghost controlled by the corresponding player.

34. The apparatus of claim 33 wherein, a player is further enabled to select the spawn location for the spawning of a character by moving the ghost to a desired location on the battlefield before being selected to spawn.

35. The apparatus of claim 22 wherein, the player is further enabled to throw a grenade.

36. The apparatus of claim 22 wherein, the plurality of battlefields includes a macho ball battlefield; the objective of the characters playing in the macho ball battlefield is to bring a ball to a target location thereon.

37. The apparatus of claim 22 wherein, the view of the game is from the profile of the battlefield.

38. The apparatus of claim 22 wherein, a character wins over an opponent (or opponents) upon the opponent being dead a predetermined number of times within a predetermined time window.

39. The apparatus of claim 38 wherein, the predetermined time frame is extended upon there being a draw between a player and an opponent.

40. The apparatus of claim 22 wherein, alternatively, a player wins over a fellow player (or fellow players), upon the player's character standing upon a spot on the battlefield for a predetermined amount of time.

41. The apparatus of claim 22 wherein, the opponent is adapted to be hit through the platforms in the event of fire.

42. The apparatus of claim 22 wherein, the plurality of platforms are divided into thick and thin platforms; the opponent is adapted to be hit through the thin platforms as the player fires thereat and vice versa.
